(19) United States
(12) Patent Application Publication
(10) Pub. No.: US 2006/0068652 A1
(43) Pub. Date: Mar. 30, 2006

(54) Component connection

(76) Inventor: Guenter Herrmann, Guetersloh (DE)

Correspondence Address: STRIKER, STRIKER & STENBY, 103 EAST NECK ROAD, HUNTINGTON, NY, 11743, US

(21) Appl. No.: 11/234,368

(22) Filed: Sep. 23, 2005

(30) Foreign Application Priority Data
Sep. 27, 2004 (DE) 10 2004 047 229.7

(51) Int. Cl. H01R 4/50

(52) U.S. Cl. 439/863

(57) ABSTRACT

A component connection between first and second components has at least a part of the first component which wraps around at least a part of the second component in a form-fit manner in an overlap region; and means for joining the parts of the first component and the second component with one another in a non-positive manner in the overlap region.

### BACKGROUND OF THE INVENTION

The present invention relates to a component connection.

Publication U.S. Pat. No. 4,800,634, for example, makes known a hub structure for bicycles, the hub being formed of an inner sleeve and an outer sleeve that accommodates at least part of the inner sleeve. For both sleeves to now ensure a non-rotable connection for transferring torques, the two sleeves are joined together via stamping in their overlapping end regions. Methods of this nature have the advantage, in particular, that workpiece deformations are prevented since heat is not introduced into the components to be joined. Eliminating or preventing component deformations—as is typically required when parts are joined via welding—makes stamped connections an economical alternative to thermal bonding methods.

On the other hand, the magnitude of the moments and forces that can be transferred via stamped connections depends decisively on the shape of the cross section of the stamped site and is typically a compromise between a primarily non-positive component connection and a partial form-fit connection. With simple stamped cross sections, this compromise in particular results in a considerable limitation in terms of the loads that can be transferred via the stamped connection.

### SUMMARY OF THE INVENTION

The object of the present invention, therefore, is to propose a component connection that prevents the disadvantages described in the related art and, in particular, represents an economical alternative to known methods, while also enabling the transfer of high forces and moments.

In keeping with these objects and with others which will become apparent hereinafter, one feature of the present invention resides, briefly stated, in a component connection between first and second components, comprising at least a part of the first component which wraps around at least a part of the second component in a form-fit manner in an overlap region; and means for joining said parts of the first component and the second component with one another in a non-positive manner in said overlap region.

Due to the fact that first and second components are joined together such that one of the components wraps around at least part of the other component in a form-fit manner, and that at least part of the first and second components is joined in this overlap region in a non-positive manner (not force-fit manner, but instead force-transmitting manner), it is ensured that the component connection is easy and economical to manufacture, and that high forces and moments can be transferred via this connection.

In an advantageous embodiment of the present invention, the form-fit connection of the components in the overlap region is realized via seaming, and the at least partial non-positive connection is realized using stamping. Connecting methods of this type are technically advanced and widespread, making it possible to implement them with a reasonable amount of outlay, also in terms of cost.

The loading capacity of the component connection can be increased even further when the first and second components to be joined both undergo a deformation induced by seaming and that defines the positive interlock of the connection.

Depending on the loads to be carried, the component connection can also be designed such that only the edge zones of the overlap region have indentations. This reduces the manufacturing costs, in particular, of the component connection.

In terms of enabling uniform introduction and transfer of load, the joined components can also have indentations that pass entirely through the overlap region. The fact that the load placed on the joined components is distributed more uniformly, the load-induced wear of the joined components is reduced in particular.

In an advantageous further development of the present invention, the indentations created in the overlap region can have any shape. This creates the possibility that the connection of the components can be adapted overall very precisely to local peak loads. In addition to reducing fabrication costs, this also results in component structures that are optimally suited to the loads that occur.

In an advantageous further development of the present invention, production tools having simple designs can be used when “connecting segments” are assigned to the components to be joined in the region of the connection to be created, it being possible for the connecting segments to be gripped easily by the deforming tools.

To ensure that indentations to be produced in the overlap region do not degrade the form-fit connection of the component already created via seaming, it is provided in an advantageous further development of the present invention that the indentations are created in the joined components such that they pass through the overlap region from the free end of the particular connecting segments to the fixed end of these connecting segments.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a schematic view of the component connection according to the present invention

FIG. 2 shows a detained view according to FIG. 1 with a schematically-depicted tool arrangement

### DESCRIPTION OF THE PREFERRED EMBODIMENTS

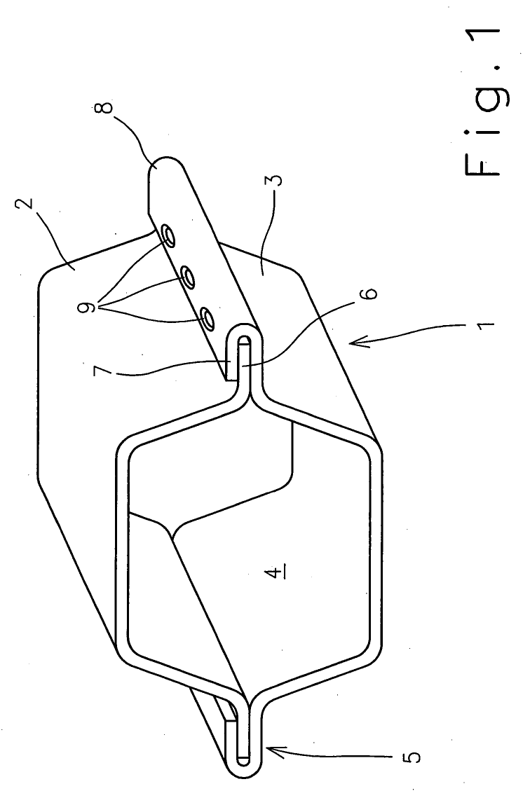

FIG. 1 shows component connection 1 according to the present invention in a schematic depiction using, as an example, a profiled support member 4 composed of a first component 2 and a second component 3. It is within the scope of the present invention that profiled support member 4 can be used in highly diverse applications, such as motor-vehicle axle construction or to manufacture supporting structures.

Flange-shaped connecting segments 6, 7 are integrally formed with substantially tub-shaped first and second components 2, 3 in their contact region 5. Flange-shaped connecting segments 6 of first component 2 point nearly horizontally away from first component 2, while flange-shaped connecting segments 7 integrally formed with second component 3 wrap around both connecting segments 6 of first component 2. In the simplest case, this wrapping-around of connecting segments 6 by first component 2 is achieved by the fact that connecting segments 7 of second component 3 are U-bent via seaming such that they wrap around flange-shaped connecting segments 6 of first component 2 in an essentially form-fit manner. It is within the scope of the present invention that connecting segments 6, 7—which are touching each other—of particular components 2, 3 can both first be brought into a form-fit connection via seaming.

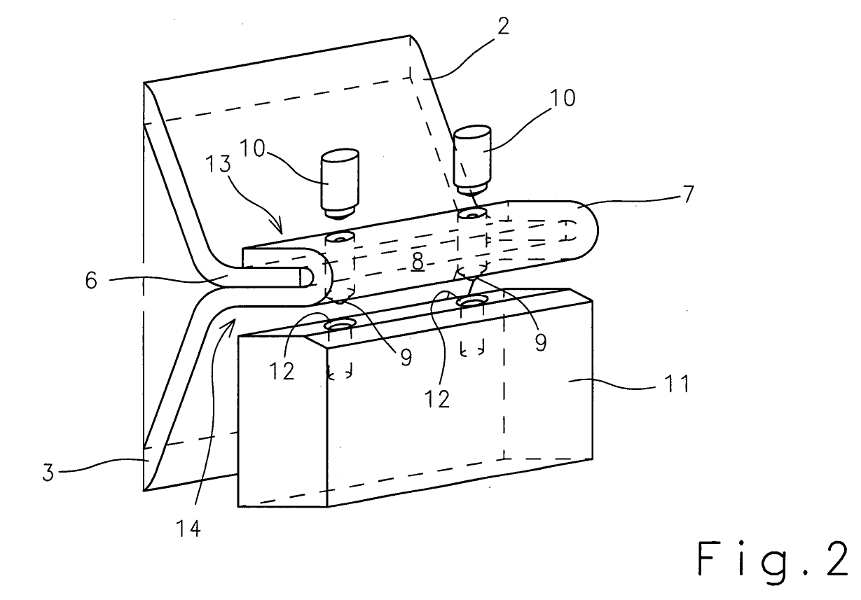

According to the present invention, this overlap region 8 formed by seaming connecting segments 6, 7 is penetrated by indentations 9 which produce—in addition to the form-fit connection induced by seaming—a further connection between particular components 2, 3 in overlap region 8, the further connection being created largely via a frictional connection. In the simplest case, indentations 9 produced in overlap region 8 can be created using positionable stamping tools 10, as shown in FIG. 2.

In a manner known per se, components 2, 3 are stamped in a manner such that connecting segments 6, 7 of particular components 2, 3 joined previously in a form-fit manner via seaming are fixed in position in workpiece counter-holders 11, workpiece counter-holder 11 including recesses 12 in the region of indentations 9 to be created. The material of connecting segments 6, 7 deformed by stamping tools 10 can move out of the way in recesses 12 when tools 10 penetrate connecting segments 6, 7. In this manner, a non-positive and form-fit connection of particular component 2, 3 is obtained which ultimately enables high forces and moments to be transferred in overlap region 8 of particular component 2, 3.

It is within the scope of the present invention that stamping tools 10 can be positioned such that indentations 9 are created only in the edge regions of overlap region 8. In cases in which the loads placed on connected components 2, 3 are essentially the same across the entire length of connected components 2, 3, indentations 9 can also extend across the entire overlap region 8, spaced nearly equidistantly.

Depending on the desired intensity of the form-fit connection between components 2, 3 to be connected via stamping, indentations 9 can also have different cross sections. In the simplest case this can be achieved by using stamping tools 10 with different shapes.

To ensure that indentations 9 to be created in components 2, 3 using stamping tools 10 after the seaming process is carried out do not damage the form-fit connection created via seaming, stamping tools 10 are guided from the at least one free end 13 of connecting segments 6, 7 integrally formed with components 2, 3 to the at least one fixed end 14 of particular connecting segment 6, 7 through overlap region 8, so that indentations 9 have their recesses in the region of free ends 13 and their raised-material areas in the region of their fixed ends 14.

It is within the scope of the present invention, however, that stamping tools 10 can also basically penetrate particular connecting segment 6, 7 on both sides of overlap region 8.

It will be understood that each of the elements described above, or two or more together, may also find a useful application in other types of constructions differing from the types described above.

While the invention has been illustrated and described as embodied in, it is not intended to be limited to the details shown, since various modifications and structural changes may be made without departing in any way from the spirit of the present invention.

Without further analysis, the foregoing will reveal fully revela the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims.

1. A component connection between first and second components, comprising at least a part of the first component which wraps around at least a part of the second component in a form-fit manner in an overlap region; and means for joining said parts of the first component and the second component with one another in a non-positive manner in said overlap region.

2. A component connection as defined in claim 1, wherein said part of the first component wraps around said part of the second component in a form-fit manner via seaming.

3. A component connection as defined in claim 1, wherein said part of the first component wraps around said part of the second component in a form-fit manner at least partially via stamping.

4. A component connection as defined in claim 1, wherein said part of the first component and said part of the second component are deformed by seaming.

5. A component connection as defined in claim 2, wherein said overlap region between said part of the first component and said part of the second component formed via seaming has edge regions provided with indentations.

6. A component connection as defined in claim 5, wherein said indentations pass entirely through said overlap region of said part of the first component and said part of the second component formed via the seaming.

7. A component connection as defined in claim 5, wherein said indentations are spaced from one another substantially equidistantly.

8. A component connection as defined in claim 5, wherein said indentations have cross-sections of any shape.

9. A component connection as defined in claim 1, wherein said part of the first component is formed integrally with the first component and said part of the second component is formed integrally with the second component at least to form said overlap region.

10. A component connection as defined in claim 5, wherein said indentations pass through said overlap region from a free end of a corresponding one of said parts to a fixed end of the corresponding one of said parts.

11. A component connection as defined in claim 5, wherein said indentations are formed as indentation produced by stamping tools which penetrate said overlap region in any direction.
